(19) United States
(12) Patent Application Publication
(10) Pub. No.: US 2018/0192369 A1
(43) Pub. Date: Jul. 5, 2018

(54) ADAPTABLE AWAKE WINDOW LENGTH FOR WIRELESS NETWORKS

(71) Applicant: INTEL IP CORPORATION, Santa Clara, CA (US)

(72) Inventors: Daniel Cohn, Raanana (IL); Solomon Trainin, Haifa (IL)

(73) Assignee: Intel IP Corporation, Santa Clara, CA (US)

(21) Appl. No.: 15/393,461

(22) Filed: Dec. 29, 2016

(51) Int. Cl. H04W 52/02; H04W 28/02

(52) U.S. Cl. CPC H04W 52/0216; H04W 84/12; H04W 28/0221; H04W 52/0229

(57) ABSTRACT

Techniques for managing a wireless network are described. An example of an electronic device configured to managing a wireless network includes a radio transceiver to enable the electronic device to communicate wirelessly with a plurality of stations over a shared channel. The electronic device also includes one or more processors to generate data frames and control the radio transceiver to transmit the data frames to the plurality of stations. The one or more processors are configured to monitor operating conditions of the wireless network and compute an awake window duration based on the operating conditions. The awake window duration describes a period of time during which stations in a power save mode are required to monitor the shared channel for an Announcement Traffic Indication Message (ATIM). The one or more processors are also configured to control the radio transceiver to transmit the awake window duration to the stations.

### TECHNICAL FIELD

This disclosure relates generally to techniques for operating a wireless network. More specifically, the disclosure describes techniques for determining an adaptable awake window duration for client devices in a wireless network.

### BACKGROUND

Minimizing power consumption in wireless communication devices is useful to provide longer battery life. A power management scheme may be implemented by a wireless communication network to allow one or more wireless communication devices (“stations”) to conserve power by switching from an active mode of operation to a power save mode of operation, such as an idle or sleep mode of operation.

In the 802.11 standard, a power saving mechanism is defined for Directional Multi Gigabit (DMG) stations where the station notifies the Access Point (AP) when it decides to go into power save mode, and the station is required to wake up during a periodic awake window. If the AP has pending traffic for a station, it may send an Announcement Traffic Indication Message (ATIM) frame during an awake window. When the station receives this frame it is required to exit power save mode. No other frames but ATIM frames (and their acknowledgments) are transmitted during the awake window.

### BRIEF DESCRIPTION OF DRAWINGS

FIG. 1 is block diagram of a wireless network configured to implement an adaptable awake window duration.

FIG. 2 is a diagram illustrating the computation of the awake window duration.

FIG. 3 is a process flow diagram summarizing an example method managing a network.

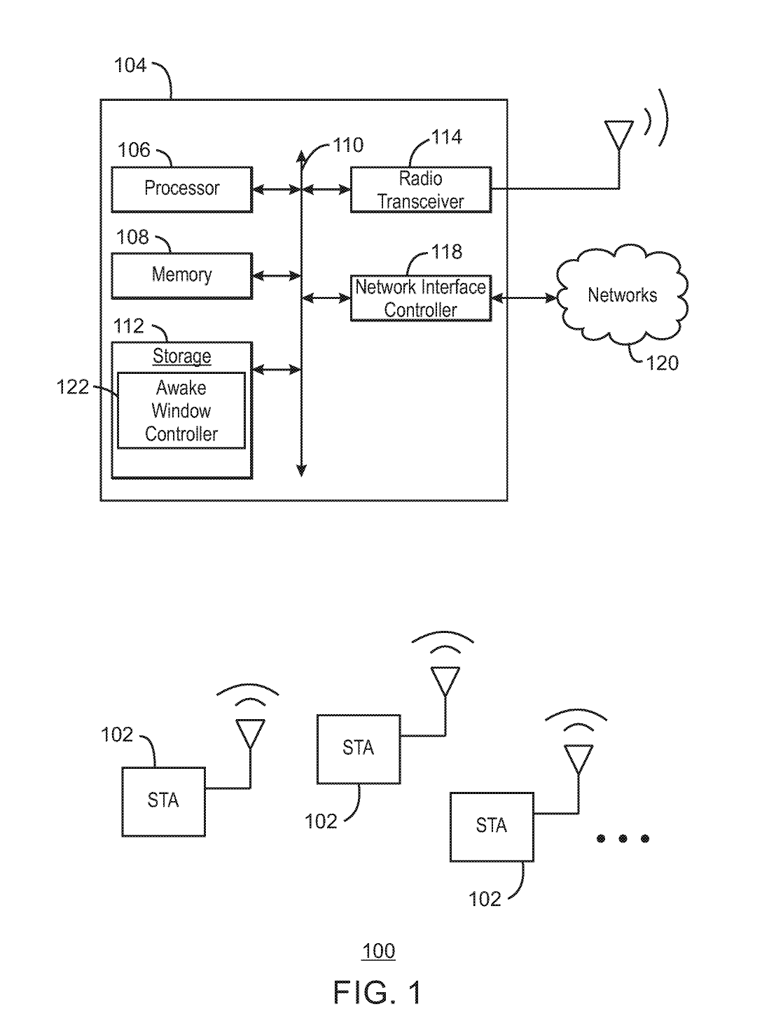

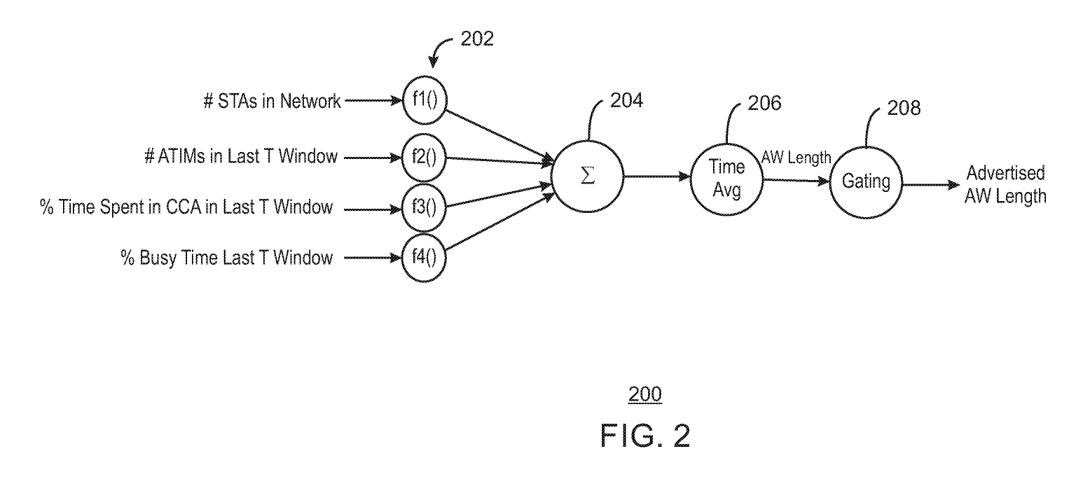

The same numbers are used throughout the disclosure and the figures to reference like components and features. Numbers in the 100 series refer to features originally found in FIG. 1; numbers in the 200 series refer to features originally found in FIG. 2; and so on.

### DETAILED DESCRIPTION

The subject matter disclosed herein relates to techniques for determining an adaptable awake window duration for client devices in a wireless network. As mentioned above, some 802.11 wireless communication standards provide a power saving mechanism in which stations are allowed to enter a power save mode and required to wake up during a periodic awake window. The awake window duration is advertised by the access point or Personal Basic Service Set (PBSS) control point (PCP) and is usually a constant duration determined by the manufacturer of the access point.

The awake window duration affects the power efficiency of the stations and may also affect the reliability and aggregate throughput of the network. A longer awake window decreases the power efficiency of stations, since they are required to stay awake for longer times and with no regular traffic. Also a longer awake window decreases the network aggregate throughput since no data frames can be transmitted during this time. On the other hand a shorter awake window may not be enough for the access point to send and receive ATIM frames to and from all of the stations within the Basic Service Set (BSS) or PBSS. ATIM frame transmission is subject to the 802.11 Carrier Sense Multiple Access with Collision Avoidance (CSMA/CA) rules and therefore transmission time is highly dependent on the activity of other stations of the same BSS and any overlapping BSSs.

The present disclosure describes techniques for setting an awake window duration that is adaptable to existing network conditions. The present disclosure also describes techniques for advertising the awake window to stations within the network. The techniques described herein may be used in any suitable 802.11 wireless communication standard, including 802.11ad (WiGig), and others.

FIG. 1 is block diagram of a wireless network configured to implement an adaptable awake window duration. The network 100 may include one or more stations 102 and a control point 104 to coordinate communications between the stations. A station 102 may be any electronic device that is configured for wireless communications using the 802.11 protocol. Examples of types of stations include desktop computers, laptop computers, tablet computers, smart phones, televisions, Internet of Things (IoT) devices, printer, and others. The control point 104 manages communications between the stations 102 and can enable the stations 102 to connect to other networks, such as a wired Local Area Network (LAN) or the Internet.

The network formed by the stations 102 and the control point 104 may be referred to as a Basic Service Set (BSS). The BSS may be communicatively coupled to one or more additional BSSs through a distribution system to form an Extended Service Set (ESS). In some cases, the BSS may be a Personal Basic Service Set (PBSS), in which case no distribution system is present. The control point 104 may be an Access Point (AP) or a PBSS control point (PCP) depending on how the BSS is configured. If the BSS is a PBSS, the control point 104 is referred to as a PBSS control point (PCP). If the BSS is a part of an ESS, the control point 104 is referred to as an Access Point.

The components of the control point 104 may be implemented as Integrated Circuits (ICs), portions thereof, discrete electronic devices, or other modules, logic, hardware, software, firmware, or a combination thereof adapted in the system, or as components otherwise incorporated within a chassis of a larger system. However, some of the components shown may be omitted, additional components may be present, and different arrangement of the components shown may occur in other implementations.

The control point 104 may include a processor 106, which may be a microprocessor, a multi-core processor, a multithreaded processor, an ultra-low voltage processor, an embedded processor, or other known processing element. The processor 106 may be a part of a system on a chip (SoC) in which the processor 106 and other components are formed into a single integrated circuit, or a single package. As an example, the processor 106 may include an Intel® Architecture Core™ based processor, such as a Quark™, an Atom™, an i3, an i5, an i7, or an MCU-class processor, or another such processor available from Intel® Corporation, Santa Clara, Calif. However, other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5, A9, or similar, processor from Apple® Inc., a Snapdragon™ processor from Qualcomm® Technologies, Inc., or an OMAP™ processor from Texas Instruments, Inc.

The processor 106 may communicate with a system memory 108 over a bus 110. Any number of memory devices may be used to provide for a given amount of system memory 108. As examples, the memory can be random access memory (RAM) in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 or LPDDR4 that will offer extensions to LPDDR2 to increase bandwidth. In various implementations the individual memory devices may be of any number of different package types such as single die package (SDP), dual die package (DDP) or quad die package (Q17P). These devices, in some embodiments, may be directly soldered onto a motherboard to provide a lower profile solution, while in other embodiments the devices are configured as one or more memory modules that in turn couple to the motherboard by a given connector. Any number of other memory implementations may be used, such as other types of memory modules, e.g., dual inline memory modules (DIMMs) of different varieties including but not limited to microDlMMs or MiniDIMMs. For example, a memory may be configured as a DDR3LM package or an LPDDR2 or LPDDR3 memory, which is soldered onto a motherboard via a ball grid array (BGA).

The control point 104 also includes a storage device 112 for persistent storage of information such as data, applications, operating systems and so forth. The storage device 112 may contain various components to enable the control point 104 to manage communications within the network 100. The storage device 112 may be coupled to the processor 106 via the bus 110. The storage device 112 may be implemented via any type of non-transitory, machine-readable medium, such as a solid state disk drive (SSDD), a hard drive, and the others. In some examples, the storage device 112 may be implemented using a micro hard disk drive (HDD). Further, any number of new technologies may be used for the storage device 112 in addition to, or instead of, the technologies described, such resistance change memories, phase change memories, holographic memories, or chemical memories, among others. For example, the control point 104 may incorporate the 3D XPOINT memories from Intel® and Micron®.

The components of the control point 104 may communicate over the bus 110. The bus 110 may include any number of technologies, including industry standard architecture (ISA), extended ISA (EISA), peripheral component interconnect (PCI), peripheral component interconnect extended (PCIx), PCI express (PCIe), or any number of other technologies. The bus 110 may be a proprietary bus, for example, used in a SoC based system. Other bus systems may be included, such as an I²C interface, an SPI interface, and point to point interfaces, among others.

The bus 110 may couple the processor 106 to a radio transceiver 114 for communications with the stations 102 and other control points. The radio transceiver 114 may include any number of frequencies and protocols, such as a WLAN unit used to implement Wi-Fi™ communications in accordance with the Institute of Electrical and Electronics Engineers (IEEE) 802.11 standard. The radio transceiver 114 may be capable of communicating over the mmwave frequency band, for example, the 60 GHz frequency band. The radio transceiver 114 may be capable of communicating over any other suitable wireless communication frequency band, in addition to or instead of the 60 GHz frequency band. In one example, radio transceiver 114 may include a multi-band wireless communication unit capable of communicating over two or more wireless communication frequency bands, e.g., the 60 GHz frequency band and the 2.4/5 GHz frequency band.

The radio transceiver 114 may be coupled to one or more antennas 116 or sets of antennas 116. The antennas 116 may include, for example, an internal and/or external RF antenna, a dipole antenna, a monopole antenna, an omni-directional antenna, a micro-strip antenna, a diversity antenna, or other type of antenna suitable for transmitting and receiving wireless communication signals.

The bus 110 may also couple the processor 106 to a network interface controller (NIC) 118 that enables the control point 104 to connect to a network 120. The network 120 may be a wired network, such as a Local Area Network (LAN), or the Internet for example.

The control point 104 periodically transmits beacon frames. Beacon frames are transmitted to announce the presence of the wireless network 100 and provide information about the network 100, such as the network's service set identifier (SSID) and other parameters. Communication between stations 102 and/or the control point 104 may be performed between beacon transmissions. The time between beacon frame transmissions is referred to as the beacon interval (BI). To maintain synchronization, the control point 104 and the stations 102 maintain a timer referred to as a Timing Synchronization Function (TSF) timer. Each beacon transmitted by the control point 104 will include a timestamp that the stations can use to update their TSF timers. For example, each station 102 may sets its TSF timer to the timestamp included in the beacon if the value of the timestamp is later than the station's TSF timer. The control point 104 also advertises a time period between beacon intervals. This time period defines a series of Target Beacon Transmission Times (TBTTs).

The control point 104 and stations 102 share a single communication channel. To avoid collisions, the control point 104 and stations 102 may be configured to implement a Carrier Sense Multiple Access with Collision Avoidance (CSMA/CA) protocol. In accordance with CSMA/CA, stations are allowed to transmit only when the communication channel is sensed to be idle. If the station finds that the channel is continuously idle for a DCF Interframe Space (DIFS) duration, it is then permitted to transmit a Request To Send (RTS) frame to the control point 104. If the medium is not idle, the station 102 waits for a period of time referred to as the Contention Window (CW), which may be incremented according to a predefined backoff algorithm.

After receiving an RTS frame from a station 102, the control point 104 may send Clear To Send (CTS) frame back to the station 102. The CTS frame indicates to the station 102 that it has contention-free access to the communication channel for a period of time referred to as a Transmit Opportunity (TXOP). The TXOP is a time interval during which the station 102 can send as many frames as possible. A time delay, referred to as the Short Interframe Space (SIFS), is imposed between the sending and receiving of frames to enable frames to be processed and responses generated. Multiple frames can be acknowledged together using a block acknowledgement (BA).

Some or all of the stations 102 may be configured to switch between an active mode and power save mode. During active mode, the station 102 is able to communicate over the network and receive data packets from the control point 104 or other stations 102. During the power save mode, the station 102 is idle, but wakes periodically to determine whether there is pending traffic to receive. Before switching to the power save mode, the station 102 may transmit a message informing the control point 104 that the station 102 is to switch from the active mode to the power-save mode. The message may include, for example, a frame having a power-mode bit set to a predefined value, e.g., one. The station 102 may then switch to the power-save mode upon receiving an acknowledgment from the control point 104.

When a station 102 in power save mode wakes to determine whether there is pending traffic for it to receive, the station 102 stays awake for a duration of time referred to as the awake window. During the awake window, the station monitors the channel for an ATIM message from the control point 104. If an ATIM message is received, the station 102 transitions from power save mode to active mode.

The awake window duration is advertised by the control point 104. The awake window duration should be long enough that the control point 104 has enough time to transmit ATIM messages to any stations 102 that may be a part of the Basic Service Set (BSS), which may be a Personal BSS (PBSS) or an Extended Service Set (ESS), for example.

In a BSS with low occupation and with only one station in power save mode, a short awake window is sufficient. For example, assuming the control point 104 uses the minimum contention window (CWmin=3 microseconds) for ATIM transmission, the maximum total channel acquisition and transaction time to send an ATIM frame would be CW+DIFS+ATIM+SIFS+BA, which equals approximately 90 us on average (assuming minimum CW window). So in this case, a 90 microsecond (us) awake window would be sufficient to ensure that any stations in power save mode would receive the ATIM message.

On the other hand, in a BSS/PBSS with high occupation and ten stations in power save mode, the PCP/AP might need to wake up all ten stations in one beacon interval (100 milliseconds). Without even considering contention with other BSS and collisions, the transmission time for the ten ATIM frames would be approximately 900 us. Considering station transmission in a collocated BSS, the awake window should be longer by a few TXOPs to ensure it will be able to transmit the required ATIM frames. Assuming default maximum TXOP duration of 1200 us, such a scenario might require an awake window duration of approximately 3500 us (assuming the PCP/AP needs to wait for another two stations to transmit).

Such a long awake window would decrease the network performance by more than 3 percent. Assuming a station power consumption in the order of 10 milliWatts (mW) in power save mode and 1 Watt (W) in receive acquisition mode (listening for an ATIM), the average power consumption would be in the order of 45 mW, compared to a 0.1 percent performance impact and 11 mW power consumption for the shorter awake window. This shows how inefficient it would be to use a long awake window when a short awake window would be sufficient. However, if the awake window is too short, the control point 104 may not be able to wake up all the stations 102 in a single beacon interval, meaning that additional beacon intervals would be required, which could add hundreds of milliseconds of latency to the network applications.

In accordance with embodiments described herein, the control point 104 can adjust the awake window duration based on current network conditions. In this way, shorter awake windows can be implemented when network conditions allow for it, while still ensuring that the awake window is long enough to successfully wake stations 102 within a single beacon interval. This results in improved power savings while ensuring that network latency is not degraded.

The control point includes an awake window controller 122 that computes an awake window duration based on current network conditions. The awake window can be recomputed on a periodic basis, or in response to changing network conditions, such as changes in the number of stations 102 and other data. A technique for computing the awake window duration is described further below in relation to FIG. 2.

The awake window duration may be advertised by the control point 104 in an awake window element of the beacon frames. However, beacon frames are not acknowledged and therefore cannot be retransmitted. In addition, stations 102 can elect to not wake up to listen for every beacon. These factors leads to the possibility that a station 102 may miss the advertisement of a new awake window duration. If a shorter awake window duration is advertised and the station 102 misses the advertisement, the station 102 will stay awake for the previous longer duration and will incur a power penalty until it receives the beacon with the updated awake window duration. If a longer awake length is advertised, the station 102 will stay awake for the previous shorter duration and may miss an ATIM frame direct to it, which would result in higher latency and possibly station disconnection if the control point determines that the station is no longer available.

In some embodiments, the awake window element includes a field referred to herein as “AW start time.” An example of the awake window element is shown below.

| | | | |
|---|---|---|---|
| Element ID | Length | AW Duration | AW start time |

In the awake window element shown above, the “element ID” field identifies the element as an awake window element, the “length” field refers to the length of the fields that follow the “length” field, the “AW duration” field is the advertised awake window duration to be applied by the stations 102, and the “AW start time” field is a time delay to be applied before giving effect to the new awake window duration. The time delay helps to ensure that every station 102 is able to receive the awake window announcement before a new awake window goes into effect. In an example embodiment, AW start time may be set equal to the beacon interval multiplied by the parameter MaxLostBeacons. MaxLostBeacons is a value advertised by the control point 104 that describes the number of lost beacons that will cause a station 102 to be disconnected from the network 100. This value for AW start time helps to ensure that every station 102 still connected to the network 100 will receive at least one beacon during the AW start time interval.

In example embodiments, the control point 104 sets the AW start time field to the four least significant bits of the TSF of the Target Beacon Transmission Time (TBTT) at which the new awake window length will go into effect. The stations 102 can start using the new advertised awake window duration when the four LSB of its own TSF timer become greater than the advertised AW start time. Additionally, the control point 104 may not change the advertised awake window duration until the AW start time has passed since the last change.

One or more of the stations 102 may be configured to declare the ability to use adaptive awake window durations. Stations that support the use of adaptive wake window durations may include an identifier to that effect in the station's DMG capabilities element field. Including the identifier in the station's DMG capabilities element field can indicate that the station supports the awake window start time capability described above. If the capability is not set for any station 102 currently in power save mode, the control 104 may choose a different policy on how to dynamically update the awake window duration, or may chose not to change the awake window duration.

FIG. 2 is a diagram illustrating the computation of the awake window duration. The computations shown in FIG. 2 are implemented by logic included in the control point 104, such as the awake window controller 122 shown in FIG. 1. The logic is embodied in hardware, such as logic circuitry or one or more processors configured to execute instructions stored as software or firmware in a non-transitory, computer-readable medium.

As shown in FIG. 2, the awake window duration is computed as a function of network conditions. FIG. 2 shows a set of four network condition functions 202, labeled F1( ), F2( ), F3( ), and F4( ). Each function operates on a different network condition input, such as the number of stations in the network 100. At least some of the network condition inputs are statistical parameters determined by monitoring network conditions existing during a time window, T.

In the example shown in FIG. 2, F1( ) is a function of the number of stations in the network, F2( ) is a function of the number of ATIMs transmitted in the most recent time window, F3( ) is a function of the percentage of time spent by the control point 104 in Clear Channel Assessment (CCA) in the most recent time window, and F4( ) is the percentage of busy time (transmitting and receiving) in the last transmission window. The phrase “busy time” refers to time that the control point 103 spends either sending or receiving data over the wireless network.

Each function may be a linear function of the network condition input that the function operates on. Additionally, the functions may be truncated to minimum and/or maximum values. The following function is provided as an example function that may be implemented by the control point 104. In the following formula, x equals the number of stations in the network.

F1(x)=150 microseconds*x, if x<=10

F1(x)=1500 microsecond, if x>10

Similar formulas may be used for each function. While the formulas may vary depending on the design details of a particular implementation, it will be appreciated that a greater number of stations in the network, a higher number of transmitted ATIM frames, longer time spent by the control point 104 in CCA, and longer busy time will result in a longer awake window length.

The contributions from each of the functions 202 are added by summation block 204. The output of the summation block 204 is sent to a time averaging block 206. The time averaging block 206 applies a smoothing algorithm to the data to avoid high sensitivity to short-term changes in the network condition input. For example, the time averaging block 206 may perform exponential smoothing or a moving average.

The output of the time averaging block 206 is the computed awake window duration. In some embodiments, the computed awake window duration may be sent to a gating block 208, which is used to avoid overly frequent changes in the awake window duration advertising. For example, an awake window duration would be advertised only if the current value differs from the previously advertised value by at least a predetermined threshold, and/or if the time since the previous change in the advertised awake window duration exceeds a time threshold. If the computed awake window duration satisfies the gating rules applied by the gating block 208, the gating block outputs a new awake window duration to be advertised by the control point 104.

It will be appreciated that the computation shown in FIG. 2 is just one example technique for computing an awake window duration. In an actual implementation, the computation of the awake window duration may include fewer or more functions, and may take into account different network condition inputs than what is described in relation to FIG. 2. Furthermore, the time averaging block 206 and/or gating block 208 may be eliminated or other blocks may be added.

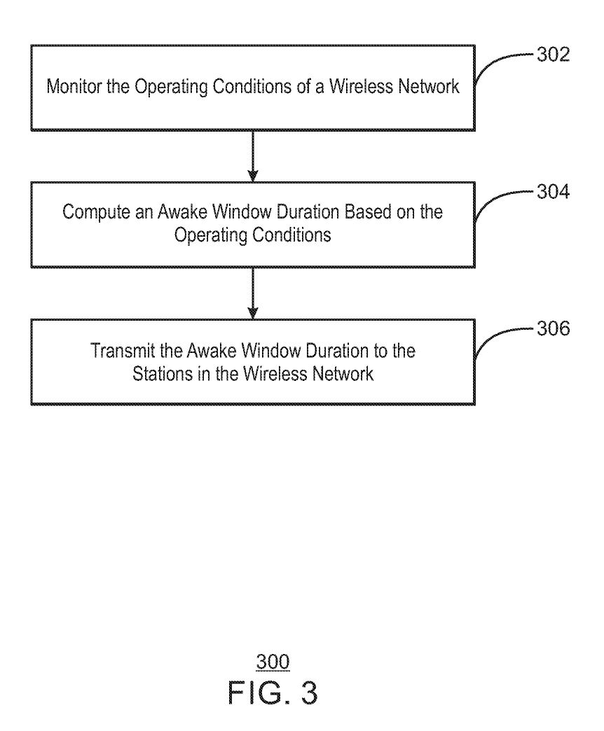

FIG. 3 is a process flow diagram summarizing an example method managing a network. The method 300 may be performed by the control point 104 shown in FIG. 1 and implemented by logic included therein. The logic is embodied in hardware, such as logic circuitry or one or more processors configured to execute instructions stored as software or firmware in a non-transitory, computer-readable medium.

At block 302, the control point 104 monitors operating conditions of a wireless network. The wireless network includes a plurality of stations sharing a wireless communication channel. The operating conditions may describe any relevant condition of the network, such as the number of stations connected to the network, the number of stations in power save mode, and others. The operating conditions may also be statistical figures describing, for example, a number of events occurring during a time window such as a number of ATIMs transmitted. The operating conditions may also be statistical figures describing a percentage of time spent in Clear Channel Assessment (CCA), a percentage of busy time, and others.

At block 304, an awake window duration is computed based on the operating conditions. The awake window duration describes a period of time during which stations in a power save mode are required to monitor the communication channel for an Announcement Traffic Indication Message (ATIM). The awake window duration may be computed as described above in relation to FIG. 2.

At block 306, the awake window duration is transmitted to the stations. The awake window duration may be advertised in beacons. In some embodiments, a new awake window duration may be implemented only after a specified time delay. This may enable all of the stations to receive the new awake window duration before it goes into effect.

The method 300 should not be interpreted as meaning that the blocks are necessarily performed in the order shown. Furthermore, fewer or greater actions can be included in the method 300 depending on the design considerations of a particular implementation.

### Examples

Example 1 is an electronic device for managing a wireless network. The electronic device includes a radio transceiver to enable the electronic device to communicate wirelessly with a plurality of stations over a shared channel. The electronic device also includes one or more processors to generate data frames and control the radio transceiver to transmit the data frames to the plurality of stations. The one or more processors is to monitor operating conditions of the wireless network and compute an awake window duration based on the operating conditions. The awake window duration describes a period of time during which stations in a power save mode are required to monitor the shared channel for an Announcement Traffic Indication Message (ATIM). The one or more processors is to control the radio transceiver to transmit the awake window duration to the stations.

Example 2 includes the electronic device of example 1, including or excluding optional features. In this example, the awake window duration is applied by the stations after a predetermined time delay.

Example 3 includes the electronic device of any one of examples 1 to 2, including or excluding optional features. In this example, the awake window duration is applied by the stations after a time delay specified by the electronic device.

Example 4 includes the electronic device of any one of examples 1 to 3, including or excluding optional features. In this example, the awake window duration is applied by the stations after a time delay approximately equal to a time period between beacon transmissions multiplied by a number of lost beacons that will cause a station to be disconnected from the wireless network.

Example 5 includes the electronic device of any one of examples 1 to 4, including or excluding optional features. In this example, the awake window duration is advertised by the electronic device in a beacon frame.

Example 6 includes the electronic device of any one of examples 1 to 5, including or excluding optional features. In this example, the operating conditions include a number of stations in the wireless network.

Example 7 includes the electronic device of any one of examples 1 to 6, including or excluding optional features. In this example, the operating conditions include a number of ATIMs transmitted over a specified time window.

Example 8 includes the electronic device of any one of examples 1 to 7, including or excluding optional features. In this example, the operating conditions include a percentage of busy time spent by the electronic device over a specified time window.

Example 9 includes the electronic device of any one of examples 1 to 8, including or excluding optional features. In this example, the operating conditions include a percentage of time spent by the electronic device in Clear Channel Assessment (CCA) over a specified time window.

Example 10 includes the electronic device of any one of examples 1 to 9, including or excluding optional features. In this example, the electronic device is a an access point or Personal Basic Service Set (PBSS) control point (PCP) that uses an Institute of Electrical and Electronics Engineers (IEEE) 802.11ad wireless communication standard.

Example 11 is a tangible, non-transitory, computer-readable medium storing instructions that, when executed by a processor, direct the processor to manage a wireless network. The wireless network includes a plurality of stations sharing a wireless communication channel. The computer-readable medium includes instructions that direct the processor to monitor operating conditions of the wireless network and compute an awake window duration based on the operating conditions. The awake window duration describes a period of time during which stations in a power save mode are required to monitor the wireless communication channel for an Announcement Traffic Indication Message (ATIM). The computer-readable medium also includes instructions that direct the processor to control a radio transceiver to transmit the awake window duration to the plurality of stations.

Example 12 includes the computer-readable medium of example 11, including or excluding optional features. In this example, the awake window duration is applied by the stations after a predetermined time delay.

Example 13 includes the computer-readable medium of any one of examples 11 to 12, including or excluding optional features. In this example, the computer-readable medium includes instructions to direct the processor to determine a start time for the awake window duration, and control the radio transceiver to transmit the start time to the plurality of stations. The awake window duration is applied by the stations after the start time.

Example 14 includes the computer-readable medium of any one of examples 11 to 13, including or excluding optional features. In this example, the awake window duration is applied by the stations after a time delay approximately equal to a time period between beacon transmissions multiplied by a number of lost beacons that will cause a station to be disconnected from the wireless network.

Example 15 includes the computer-readable medium of any one of examples 11 to 14, including or excluding optional features. In this example, to transmit the awake window duration to the plurality of stations includes to advertise the awake window duration in a beacon frame.

Example 16 includes the computer-readable medium of any one of examples 11 to 15, including or excluding optional features. In this example, the operating conditions include a number of stations in the wireless network.

Example 17 includes the computer-readable medium of any one of examples 11 to 16, including or excluding optional features. In this example, the operating conditions include a number of ATIMs transmitted over a specified time window.

Example 18 includes the computer-readable medium of any one of examples 11 to 17, including or excluding optional features. In this example, the operating conditions include a percentage of busy time spent over a specified time window.

Example 19 includes the computer-readable medium of any one of examples 11 to 18, including or excluding optional features. In this example, the operating conditions include a percentage of time spent in Clear Channel Assessment (CCA) over a specified time window.

Example 20 includes the computer-readable medium of any one of examples 11 to 19, including or excluding optional features. In this example, the wireless network is an Institute of Electrical and Electronics Engineers (IEEE) 802.11ad wireless network.

Example 21 is a method of operating a wireless network. The wireless network includes a plurality of stations sharing a wireless communication channel. The method includes monitoring operating conditions of the wireless network, and computing an awake window duration based on the operating conditions. The awake window duration describes a period of time during which stations in a power save mode are required to monitor the wireless communication channel for an Announcement Traffic Indication Message (ATIM). The method also includes controlling a radio transceiver to transmit the awake window duration to the plurality of stations.

Example 22 includes the method of example 21, including or excluding optional features. In this example, the method includes applying the awake window duration only after a predetermined time delay if the awake window duration is different from a previously advertised awake window duration.

Example 23 includes the method of any one of examples 21 to 22, including or excluding optional features. In this example, the method includes determining a start time for the awake window duration and controlling the radio transceiver to transmit the start time to the plurality of stations. The awake window duration is applied by the stations after the start time. Optionally, the start time provides a time delay approximately equal to a time period between beacon transmissions multiplied by a number of lost beacons that will cause a station to be disconnected from the wireless network.

Example 24 includes the method of any one of examples 21 to 23, including or excluding optional features. In this example, controlling the radio transceiver to transmit the awake window duration to the plurality of stations includes advertising the awake window duration in a beacon frame.

Example 25 includes the method of any one of examples 21 to 24, including or excluding optional features. In this example, the operating conditions include a number of stations in the wireless network.

Example 26 includes the method of any one of examples 21 to 25, including or excluding optional features. In this example, the operating conditions include a number of ATIMs transmitted over a specified time window.

Example 27 includes the method of any one of examples 21 to 26, including or excluding optional features. In this example, the operating conditions include a percentage of busy time over a specified time window.

Example 28 includes the method of any one of examples 21 to 27, including or excluding optional features. In this example, the operating conditions include a percentage of time spent in Clear Channel Assessment (CCA) over a specified time window.

Example 29 includes the method of any one of examples 21 to 28, including or excluding optional features. In this example, the wireless network is an Institute of Electrical and Electronics Engineers (IEEE) 802.11ad wireless network.

Example 30 is an apparatus for managing a wireless network. The apparatus includes means for monitoring operating conditions of a wireless network, wherein the wireless network includes a plurality of stations sharing a wireless communication channel. The apparatus also includes means for computing an awake window duration based on the operating conditions, wherein the awake window duration describes a period of time during which stations in a power save mode are required to monitor the wireless communication channel for an Announcement Traffic Indication Message (ATIM). The apparatus also includes means for transmitting the awake window duration to the plurality of stations.

Example 31 includes the apparatus of example 30, including or excluding optional features. In this example, if the awake window duration is different from a previously advertised awake window duration, the awake window duration is applied only after a predetermined time delay.

Example 32 includes the apparatus of any one of examples 30 to 31, including or excluding optional features. In this example, the apparatus includes means for determining a start time for the awake window duration, wherein the awake window duration is applied by the stations after the start time. Optionally, the start time provides a time delay approximately equal to a time period between beacon transmissions multiplied by a number of lost beacons that will cause a station to be disconnected from the wireless network.

Example 33 includes the apparatus of any one of examples 30 to 32, including or excluding optional features. In this example, the means for transmitting the awake window duration to the plurality of stations advertises the awake window duration in a beacon frame.

Example 34 includes the apparatus of any one of examples 30 to 33, including or excluding optional features. In this example, the operating conditions include a number of stations in the wireless network.

Example 35 includes the apparatus of any one of examples 30 to 34, including or excluding optional features. In this example, the operating conditions include a number of ATIMs transmitted over a specified time window.

Example 36 includes the apparatus of any one of examples 30 to 35, including or excluding optional features. In this example, the operating conditions include a percentage of busy time over a specified time window.

Example 37 includes the apparatus of any one of examples 30 to 36, including or excluding optional features. In this example, the operating conditions include a percentage of time spent in Clear Channel Assessment (CCA) over a specified time window.

Example 38 includes the apparatus of any one of examples 30 to 37, including or excluding optional features. In this example, the apparatus is an access point or Personal Basic Service Set (PBSS) control point (PCP) that uses an Institute of Electrical and Electronics Engineers (IEEE) 802.11ad wireless communication standard.

Some embodiments may be implemented in one or a combination of hardware, firmware, and software. Some embodiments may also be implemented as instructions stored on the tangible non-transitory machine-readable medium, which may be read and executed by a computing platform to perform the operations described. In addition, a machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An electronic device for managing a wireless network comprising:
a radio transceiver to enable the electronic device to communicate wirelessly with a plurality of stations over a shared channel; and
one or more processors to generate data frames and control the radio transceiver to transmit the data frames to the plurality of stations, wherein the one or more processors is to:
monitor operating conditions of the wireless network;
compute an awake window duration based on the operating conditions, wherein the awake window duration describes a period of time during which stations in a power save mode are required to monitor the shared channel for an Announcement Traffic Indication Message (ATIM); and
control the radio transceiver to transmit the awake window duration to the stations.

2. The electronic device of claim 1, wherein the awake window duration is applied by the stations after a predetermined time delay.

3. The electronic device of claim 1, wherein the awake window duration is applied by the stations after a time delay specified by the electronic device.

4. The electronic device of claim 1, wherein the awake window duration is applied by the stations after a time delay approximately equal to a time period between beacon transmissions multiplied by a number of lost beacons that will cause a station to be disconnected from the wireless network.

5. The electronic device of claim 1, wherein the awake window duration is advertised by the electronic device in a beacon frame.

6. The electronic device of claim 1, wherein the operating conditions comprise a number of stations in the wireless network.

7. The electronic device of claim 1, wherein the operating conditions comprise a number of ATIMs transmitted over a specified time window.

8. The electronic device of claim 1, wherein the operating conditions comprise a percentage of busy time spent by the electronic device over a specified time window.

9. The electronic device of claim 1, wherein the operating conditions comprise a percentage of time spent by the electronic device in Clear Channel Assessment (CCA) over a specified time window.

10. The electronic device of claim 1, wherein the electronic device is a an access point or Personal Basic Service Set (PBSS) control point (PCP) that uses an Institute of Electrical and Electronics Engineers (IEEE) 802.11ad wireless communication standard.

11. A tangible, non-transitory, computer-readable medium comprising instructions that, when executed by a processor, direct the processor to manage a wireless network, the instructions to direct the processor to:
monitor operating conditions of a wireless network, the wireless network comprising a plurality of stations sharing a wireless communication channel;
compute an awake window duration based on the operating conditions, wherein the awake window duration describes a period of time during which stations in a power save mode are required to monitor the wireless communication channel for an Announcement Traffic Indication Message (ATIM); and
control a radio transceiver to transmit the awake window duration to the plurality of stations.

12. The computer-readable medium of claim 11, wherein the awake window duration is applied by the stations after a predetermined time delay.

13. The computer-readable medium of claim 11, comprising instructions to direct the processor to:
determine a start time for the awake window duration; and
control the radio transceiver to transmit the start time to the plurality of stations, wherein the awake window duration is applied by the stations after the start time.

14. The computer-readable medium of claim 11, wherein the awake window duration is applied by the stations after a time delay approximately equal to a time period between beacon transmissions multiplied by a number of lost beacons that will cause a station to be disconnected from the wireless network.

15. The computer-readable medium of claim 11, wherein to transmit the awake window duration to the plurality of stations comprises to advertise the awake window duration in a beacon frame.

16. The computer-readable medium of claim 11, wherein the operating conditions comprise a number of stations in the wireless network.

17. The computer-readable medium of claim 11, wherein the operating conditions comprise a number of ATIMs transmitted over a specified time window.

18. The computer-readable medium of claim 11, wherein the operating conditions comprise a percentage of busy time spent over a specified time window.

19. The computer-readable medium of claim 11, wherein the operating conditions comprise a percentage of time spent in Clear Channel Assessment (CCA) over a specified time window.

20. The computer-readable medium of claim 11, wherein the wireless network is an Institute of Electrical and Electronics Engineers (IEEE) 802.11ad wireless network.

21. A method of operating a wireless network comprising:
monitoring operating conditions of a wireless network, the wireless network comprising a plurality of stations sharing a wireless communication channel;
computing an awake window duration based on the operating conditions, wherein the awake window duration describes a period of time during which stations in a power save mode are required to monitor the wireless communication channel for an Announcement Traffic Indication Message (ATIM); and
controlling a radio transceiver to transmit the awake window duration to the plurality of stations.

22. The method of claim 21, comprising, if the awake window duration is different from a previously advertised awake window duration, applying the awake window duration only after a predetermined time delay.

23. The method of claim 21, comprising determining a start time for the awake window duration and controlling the radio transceiver to transmit the start time to the plurality of stations, wherein the awake window duration is applied by the stations after the start time.

24. The method of claim 23, wherein the start time provides a time delay approximately equal to a time period between beacon transmissions multiplied by a number of lost beacons that will cause a station to be disconnected from the wireless network.

25. The method of claim 21, wherein controlling the radio transceiver to transmit the awake window duration to the plurality of stations comprises advertising the awake window duration in a beacon frame.
